(19) United States
(12) Patent Application Publication
(10) Pub. No.: US 2002/0131447 A1
(43) Pub. Date: Sep. 19, 2002

(54) System and method for wireless packet data content switch

(76) Inventors: Shridhar Krishnamurthy, Coppell, TX (US); Jogen K. Pathak, Dallas, TX (US)

Correspondence Address: R. SCOTT RHOADES, STRASBURGER & PRICE, LLP, 901 MAIN STREET, SUITE 4300, DALLAS, TX, 75202-3794, US

(21) Appl. No.: 09/839,830

(22) Filed: Apr. 19, 2001

Related U.S. Application Data
(63) Continuation-in-part of application No. 09/718,723, filed on Nov. 22, 2000.
(60) Provisional application No. 60/192,169, filed on Mar. 27, 2000.
(60) Provisional application No. 60/251,929, filed on Dec. 7, 2000.

(51) Int. Cl. H04Q 7/00; H04J 3/22

(52) U.S. Cl. 370/465; 370/328

(57) ABSTRACT

A system for processing wireless packet data is provided. The system includes a gateway radio packet interface receiving radio packet data from a gateway radio packet node. A content switch system coupled to the gateway radio packet interface receives the radio packet data, extracts one or more predetermined data fields from the radio packet data, and performs one or more predetermined actions based on the extracted data fields. A serving radio packet interface coupled to the content switch system transmits the radio packet data to a serving radio packet node.

### RELATED APPLICATIONS

This application claims priority to U.S. patent application Ser. No. 09/718,713, entitled “SYSTEM AND METHOD FOR WIRELESS CONTENT SWITCH,” filed Nov. 22, 2000, and Provisional Patent Application serial No. 60/192,169, filed Dec. 7, 2000, which are commonly owned and assigned with the present application.

### FIELD OF THE INVENTION

The present invention pertains to the field of data transmission over limited bandwidth shared medium networks like wireless networks. More specifically, the invention relates to a system and method for a wireless packet data content switch that allows content servers to provide data to wireless devices without requiring special adaptation of new and existing content servers, networks, public Internet protocols specifically for different wireless network protocols for reliable delivery of information from content server to the mobile user, definition, decision, and enforcement of wireless carriers and content providers, including businesses, to implement their corporate policies in a consistent fashion, group communications, flexible and adaptive quality of service to create the best possible user experience while optimizing the usage of critical resources in the network, and end-to-end transaction security to an acceptable level.

### BACKGROUND OF THE RELATED ART

The transmission of wireless voice and data (hereinafter referred to as “data”) is known in the art. Many processes for transmitting wireless data have been proposed and implemented. For example, wireless data can be transmitted in a wireless data channel, such as by the use of code division multiple access, time division multiple access, frequency division multiple access, or other procedures or combinations of procedures whereby a code group, time slot or other similar structures can be used to create a radio channel for transmitting data. One drawback associated with such radio data channels is that if no data is being transmitted, or any other data besides the user's data, then the overall use of the radio bandwidth efficiency decreases, because it is not possible to cover and re-deploy that bandwidth for other data transmission functions.

Circuit switched and packet switched data transmission has also been used to transmit data over the radio (or “air”) interface. The packet switched data is also known as packet data. The general packet radio service (GPRS) standard is a public standard that is being delivered to facilitate the provision of packet-switched services to a mobile user. The GPRS system utilizes a structure wherein a gateway GPRS support node is coupled to the Internet. The gateway GPRS support node receives packet data from the Internet, such as in the Hypertext Transfer Protocol (HTTP) Internet protocol (IP) or X.25 data formats, and then processes the data to determine the address to which the packet data should be sent and the format of the transport that it should be sent in, such as the GPRS Tunneling Protocol (GTP). The gateway GPRS support node then transmits the data, such as an HTTP packet, to a serving GPRS support node that is associated with the address. The serving GPRS support node then coordinates with a base station system to transmit the HTTP packet to the mobile station. A generic mobile network model can be derived based on the Open System Interconnect (OSI) for the invention discussed here. The network model defines logical structure and the physical realization may be implemented as a combination of different functionalities on different physical platforms similar to the concepts of OSI. All public and private network standards, such as GPRS, Universal Mobile Telecommunications System (UMTS), CDMA2000, Ricochet, and others comply with the model at the logical level.

While these standards define data delivery functionality, mere delivery of raw bandwidth over wireless media without an acceptable service experience will result in limited market acceptance of wireless data in the business and consumer environments. In data networking, quality implies the process of delivering data in a reliable and timely manner with consistent precision, where the definition of reliable, timely, and precision depends on the type of traffic. A user browsing the web, but not using FTP for file downloads or not streaming multimedia information, may have a different “perception of service” than a business user of large corporate databases of financial information, multimedia conferencing, or voice. Service quality is a continuum, defined by the network performance characteristics that are most important to a user of the service. Service quality requirements further vary by application and service subscription that is determined by the Service Level Agreements. The goal of a wireless service provider is to maximize the end user satisfaction while optimizing use of critical wireless bandwidth. The barrier to service deployment of mobile wireless data has been the absence of acceptable mechanisms to deliver sufficient bandwidth for an acceptable end user experience. The Quality of Service defined in the GPRS, UMTS, and other networks are necessary and sufficient for providing acceptable service quality over wireless networks, but fail to address the problems created by network and service deployment and optimization.

### SUMMARY OF THE INVENTION

In accordance with the present invention, a system and method for a wireless content switch are provided that overcome known shortcomings with providing wireless data access.

In particular, a system and method for a wireless content switch are provided that allow data to be provided to wireless devices over various networks in a manner that supports additional processing of the data, that further enables different types of devices to simultaneously receive the data. The present invention provides a network-centric approach for different wireless networks through an underlying infrastructure, with no requirements for mobile capability, so as to consistently address service quality issues.

In accordance with an exemplary embodiment of the present invention, a system for processing wireless packet data is provided. The system includes a gateway interface receiving data from and sending data to a gateway node. A content switch system coupled to the gateway interface receives the data, extracts one or more predetermined data fields from the data, and performs one or more predetermined actions based on the extracted data fields. A serving interface coupled to the content switch system transmits the data to a serving node.

The present invention provides many important technical advantages. One important technical advantage of the present invention is a system and method for wireless content switching that allows data in a wireless network to be switched based upon the content of the packet data. The present invention thus allows quality of service management, group communication management, and management of other services to be performed that would not be possible to provide from a remote server.

Those skilled in the art will further appreciate the advantages and superior features of the invention together with other important aspects thereof on reading the detailed description that follows in conjunction with the drawings.

### BRIEF DESCRIPTION OF THE SEVERAL VIEWS OF THE DRAWINGS

FIG. 1 is a diagram of a system for providing wireless content processing capability in a wireless network in accordance with an exemplary embodiment of the present invention;

FIG. 2 is a diagram of a system for providing wireless content switching functionality in accordance with an exemplary embodiment of the present invention;

FIG. 3 is a diagram of a system for providing wireless data services in accordance with an exemplary embodiment of the present invention;

FIG. 4 is a diagram of a system for providing wireless content switch functionality in accordance with an exemplary embodiment of the present invention;

FIG. 5 is a diagram of an exemplary data frame for transmitting data in accordance with an exemplary embodiment of the present invention;

FIG. 6 is a flow chart of a method for processing radio packet data in accordance with an exemplary embodiment of the present invention;

FIG. 7 is a flow chart of a method for providing quality of service functionality in a wireless content switch in accordance with an exemplary embodiment of the present invention; and

FIG. 8 is a flow chart of a method for providing multicast functionality in accordance with an exemplary embodiment of the present invention.

### DETAILED DESCRIPTION OF THE INVENTION

In the description that follows, like parts are marked throughout the specification and drawings with the same reference numerals, respectively. The drawing figures might not be to scale, and certain components can be shown in generalized or schematic form and identified by commercial designations in the interest of clarity and conciseness.

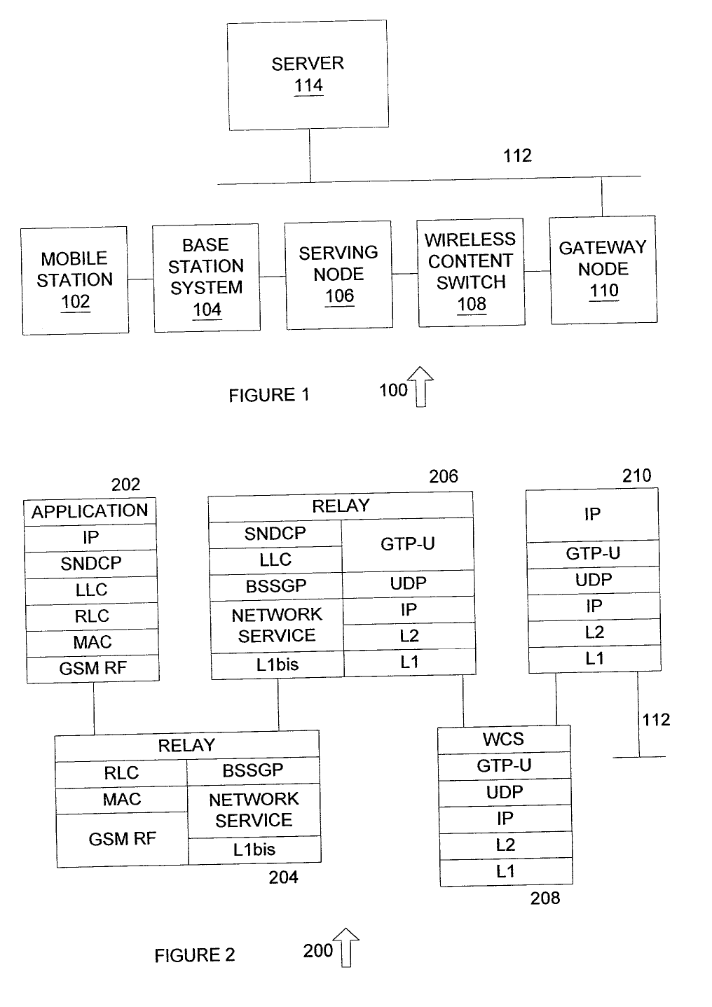

FIG. 1 is a diagram of a system 100 for providing wireless content processing capability in a wireless packet network in accordance with an exemplary embodiment of the present invention. System 100 includes mobile station 102, base station system 104, serving node 106, wireless content switch 108, and gateway node 110, which is coupled to communications medium 112. Communications medium 112 can be the Internet, a local area network, a wide area network, a fiber optic network, the public switched telephone network, other suitable media, or a suitable combination of such media. Mobile station 102, base station system 104, serving node 106, and gateway node 110 form a standard logical radio packet data transmission network. Wireless content switch 108 is coupled between gateway node 110 and serving GRPS support node 106, and processes gateway GPRS tunneling protocol radio packet data in order to provide additional content switching functionality.

In one exemplary embodiment, wireless content switch 108 can receive GPRS tunneling protocol format packet data from gateway node 110, and can determine additional processing that may be required based upon the mobile station 102, the type of content in the packet, priority data, quality of service data, multicasting functionality, or other suitable functions, such as those described and disclosed in U.S. patent application Ser. No. 09/718,713, entitled “SYSTEM AND METHOD FOR WIRELESS CONTENT SWITCH,” filed Nov. 22, 2000, which is commonly owned and assigned with the present application, and which is hereby incorporated by reference for all purposes.

Likewise, wireless content switch 108 can receive GPRS tunneling protocol packet data from serving node 106, and can process the GPRS tunneling protocol packet data to perform additional functionality prior to transmitting the packet data to gateway node 110. Wireless content switch 108 thus interfaces seamlessly into the GPRS standard network to provide additional wireless data processing functionality that cannot presently be provided from the server or mobile station 102. For example, if server 114 is a wireless application server that is performing quality of service management over communications medium 112, it would not be able to readily determine the status of gateway node 110 and serving node 106, such as the total bandwidth being used, the bandwidth being used in a virtual private network, operable mobile stations, or other suitable status data. Likewise, deploying wireless content switch 108 at server 114 limits the functionality that can be provided by wireless content switch 108 to packet data being provided through server 114 to mobile station 102. By deploying wireless content switch 108 between gateway node 110 and serving node 106, it is possible to provide wireless content switching functionality on radio packet data regardless of whether it comes from server 114 or from any other server accessible over communications medium 112.

In operation, wireless content switch 108 interfaces with gateway node 110 and serving node 106 to extract data fields from GPRS tunneling protocol packet data or other suitable packet data, to process the extracted data based upon predetermined functionality, and to store modified data in the GPRS tunneling protocol packet data or other suitable radio packet data, so as to provide wireless content switching functionality.

FIG. 2 is a diagram of a system 200 for providing wireless content switching functionality in accordance with an exemplary embodiment of the present invention in a GPRS network. System 200 includes a mobile station 202, a base station system 204, a serving GPRS support node 206, a wireless content switch 208, and a gateway GPRS support node 210, wherein each of these systems further comprises additional systems for processing data in accordance with Open Systems Interconnection (OSI) standards, Global System for Mobile Communications (GSM) standards, or other suitable standards.

Packet data reaches gateway GPRS support node 210 from communications medium 112 in an Internet protocol processing layer. The Internet protocol processing layer also extracts GPRS tunneling protocol packet data using a GTP-U layer, user datagram protocol packets using a User Datagram Protocol (UDP) layer, and physical layer L1 and data link layer L2 data, using L1 and L2 layer protocols. The extracted data is then processed in accordance with the GPRS wireless network protocol to determine the serving GPRS support node 206 that the data should be transferred to, in addition to base station system 204 and mobile station 202 criteria.

Wireless content switch 208 is coupled to gateway GPRS support node 210 and performs processing using a wireless content switch application layer, a GTP-U layer, a UDP layer, an Internet protocol layer, and an L1 and L2 layer. Wireless content switch 208 can extract radio packet data from the GTP-U processing layer, and can perform additional processing to support quality of service functionality, multicasting functionality, and other functionality, such as that described in U.S. patent application Ser. No. 09/718,713. The wireless content switch application layer also receives data from the UDP layer, the IP layer, and the L1 and L2 layers in support of this functionality. Wireless content switch 208 then transmits data to serving GPRS support node 206 after the process data is stored back into the GTP radio packet data.

Serving GPRS support node 206 interfaces with wireless content switch 208 at the GTP-U layer, UDP later, IP layer, L2 layer, and L1 layer, and performs additional processing to determine the location of a mobile station 202 and base station system 204 serving the mobile station. Serving GPRS support node 206 transmits the packet data to a base station system 204 via a relay layer, and also performs additional subnetwork convergence protocol (SNDCP) processing, logical link control (LLC) processing, base station subsystem GPRS protocol (BSSGP) processing, network service processing, and L1bis processing.

Base station system 204 performs receives the various layers of data from serving GPRS support node 206 over a relay connection or other suitable connections and performs radio link control (RLC) processing, medium access control (MAC) processing, GSM radio frequency (GSMRF) control, and additional processing so as to allow the radio packet data to be transmitted to the correct mobile station that the radio packet data is addressed to, as per the standard specification-compliant implementation.

Mobile station 202 includes RF, medium access control, radio link control, logical layer control, SNDCP and IP processing functionality, so as to allow mobile station 202 to function within one or more wireless networks, including a GPRS wireless network. In addition, mobile station 202 can include one or more applications which interface with wireless content switch applications on wireless content switch 208, server applications operating on server 114, or other suitable applications. The specific presence or implementation of an application on the mobile station is not required. Configuration data for mobile station 202 can be stored at wireless content switch 208, server 114, or at other suitable locations, such as in accordance with the Lightweight Directory Access Protocol (LDAP) or proprietary information exchange protocols. Likewise, wireless content switch 208 can determine the operational specifications for mobile station 202 by analyzing data extracted from the GTP-U, UDP, IP, L1, and L2 processing layers as the data being transmitted to and from mobile station 202 is processed by wireless content switch 208.

In operation, system 200 allows processing of radio packet data to facilitate quality of service, multicasting, and additional functionality for transmitting and receiving radio packet data with mobile station 202 through wireless content switch 208. Wireless content switch 208 extracts predetermined message and data fields from signalling or control messages, bearer or user data contained in the packet, or other suitable data layers, and can perform additional processing of the radio packet data to provide predetermined services to mobile station 202.

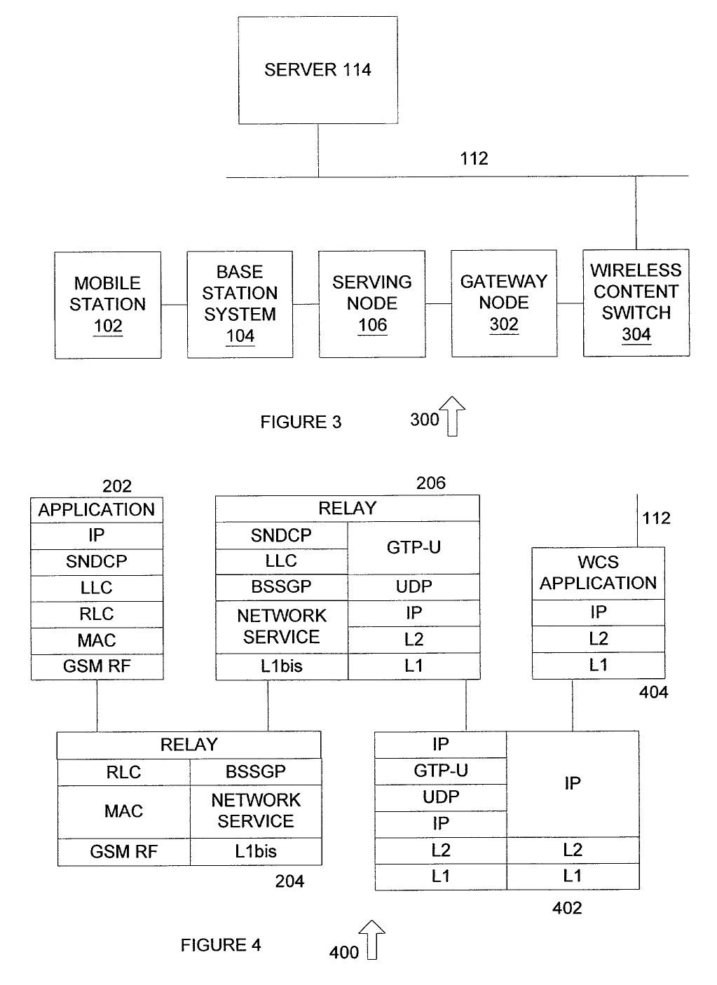

FIG. 3 is a diagram of a system 300 for providing wireless data services in accordance with an exemplary embodiment of the present invention. System 300 includes standard wireless data network system components, including gateway node 110, serving node 106, base station system 104, and mobile station 102, and further includes wireless content switch 304 disposed between gateway node 110 and communications medium 112.

Wireless content switch 304 performs analysis and modification of inbound radio packet data received from communications medium 112 prior to processing by gateway node 110, and analysis and processing of outbound radio packet data after processing is performed by gateway node 110. In this configuration, wireless content switch 304 can be deployed without modification of existing connections between gateway GPRS support node 302 and one or more serving GPRS support nodes 106.

FIG. 4 is a diagram of a system 400 for providing wireless content switch functionality in accordance with an exemplary embodiment of the present invention in the GPRS wireless data network. System 400 includes mobile station 202, base station system 204, and serving GPRS support node 206, and further includes gateway GPRS support node 402 and wireless content switch 404.

Wireless content switch 404 receives data from communications medium 112 through an Internet protocol layer, L2 layer, and L1 layer, and performs wireless content switch application processing of the received data. In this configuration, wireless content switch 404 can identify the radio packet data within the Internet protocol data format, and can perform additional processing prior to the processing that is performed by gateway GPRS support node 402 for incoming packet data. Wireless content switch 404 is coupled to gateway GPRS support node 402 through the Internet protocol, L2, and L1 layers. Gateway GPRS support node 402 then performs processing of the data received from wireless content switch 404 using the Internet protocol, GTP-U, UDP, L2, and L1 processing layers, so as to distribute the data to one or more serving GPRS support nodes 206.

In the outbound direction, packet data is received from one or more serving GPRS support nodes 206 at gateway GPRS support node 402, and is processed for transmission over communications medium 112. Wireless content switch 404 receives the processed packet data in the Internet protocol, L2, and L1 processing layers, and performs additional processing of the processed packet data as required to provide quality of service, multicasting, or other suitable functionality for one or more wireless content switch applications.

In operation, system 400 allows wireless content switch 404 to be deployed between gateway GPRS support node 402 and communications medium 112. In this configuration, the wireless content switch 404 can perform processing of packet data received from communications medium 112 prior to providing that packet data to gateway GPRS support node 402, and can receive the processed radio packet data from gateway GPRS support node 402 after it has been processed and prior to transmission over communications medium 112.

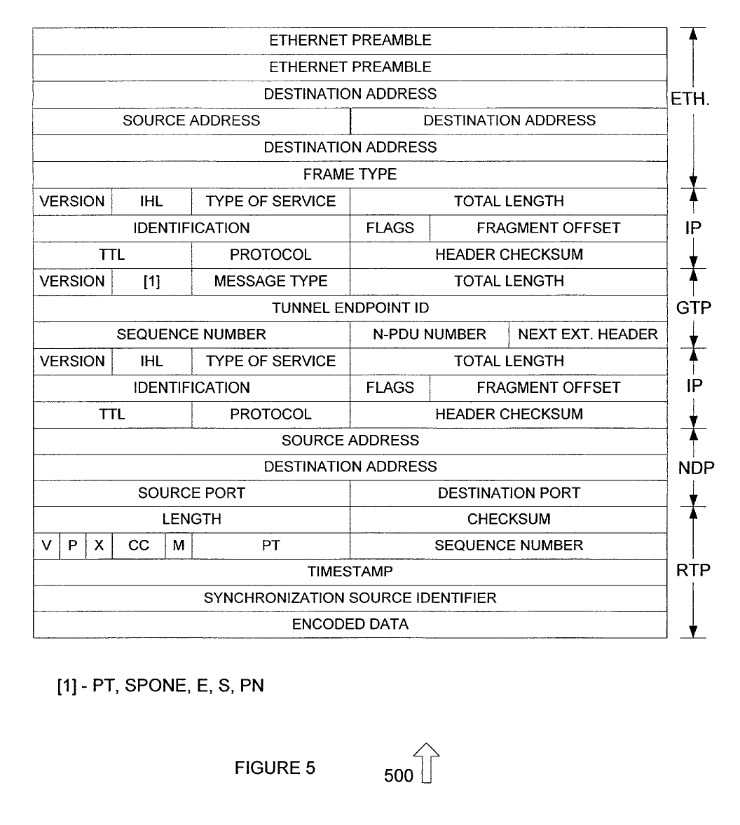

FIG. 5 is a diagram of an exemplary data frame format 500 for transmitting wireless packet data content switch control and payload data in the GPRS tunneling protocol data format, in accordance with an exemplary embodiment of the present invention. Data frame format 500 includes additional data fields that follow the standard GPRS tunneling protocol header, where such data fields are divided to facilitate processing between wireless content switch applications, mobile station 202 applications, server 114 applications, and other suitable systems.

Data frame format 500 is shown in a four octet structure. Although sizes and sequences have been provided for the data fields in data frame format 500, the sizes and sequences can be altered or modified, and the data fields shown can be left out or other suitable data fields can be added to support wireless content switch functionality, such as the functionality described herein or in U.S. patent application Ser. No. 09/718,713. The packet header can also be compressed, such as in accordance with RFC 2508, “Compressing IP/UDP/RTP Headers for Low-Speed Serial Links,” available from the Internet Engineering Task Force, or other suitable protocols.

Data frame format 500 includes an Ethernet frame segment, which is followed by an Internet Protocol segment, a GRPS Tunneling Protocol segment, a second Internet Protocol segment, a UDP segment, and a Realtime Transport Protocol (RTP) segment. The exemplary data fields shown in data frame format 500 and their corresponding sizes and functions include:

Ethernet preamble—8 octets

Ethernet destination address—4 octets.

Ethernet source address—2 octets.

Ethernet destination address—6 octets.

Ethernet frame type—4 octets.

Version number—half octet; in one exemplary embodiment can be used to determine the version and map data between versions.

IHL identifier—half octet.

Type of service—octet.

Total packet length—two octets; in one exemplary embodiment can be used to determine the required bandwidth for transmission of entire packet.

Identification—two octets.

Flags—half octet (in one exemplary embodiment can be used to indicate functional status of wireless data system components).

Fragment offset—one and one half octet.

TTL field—one octet.

Protocol field—one octet.

Header checksum field—two octets.

GTP version, PT, SPONE, E, S, PN—two octets (includes GTP version, protocol type, extension header, sequence number flag, and N-PDU number flag).

Source address field—four octets (in one exemplary embodiment can be used to store the complete address of data source so as to determine priority, application type, or changes in address).

Destination address field—four octets (in one exemplary embodiment can be used to store the complete address of data destination so as to determine priority, application type, or changes in address).

Source port field—two octets (port address of data source, in one exemplary embodiment can be used to determine priority and application type).

Destination port field—two octets (port address of data destination, in one exemplary embodiment can be used to detect changes in port assignment).

Length field—two octets.

Checksum field—two octets.

V—version number of the RTP protocol.

P—number of padding octets that should be ignored (if padding bit is set).

X—extension bit (indicates that fixed header is followed by one header extension).

CC—Contributing Source (CSRC) count (number of CSRC identifiers that follow the fixed header).

M—profile-based marker bit.

PT—payload type.

Sequence number field—two octets (sequence number of packet, in one exemplary embodiment can be used to determine whether packets are missing from sequence and need to be retransmitted).

Time stamp field—four octets.

Synchronization source identifier field—four octets.

Encoded data—variable.

In operation, data frame format 500 provides a structure for transmitting and processing data that is needed to provide wireless content switch functionality in a wireless packet data network. The data in data fields of data frame format 500 are used to support quality of service, multicasting, and other suitable functionality that is not provided for in standardized wireless packet data network architectures.

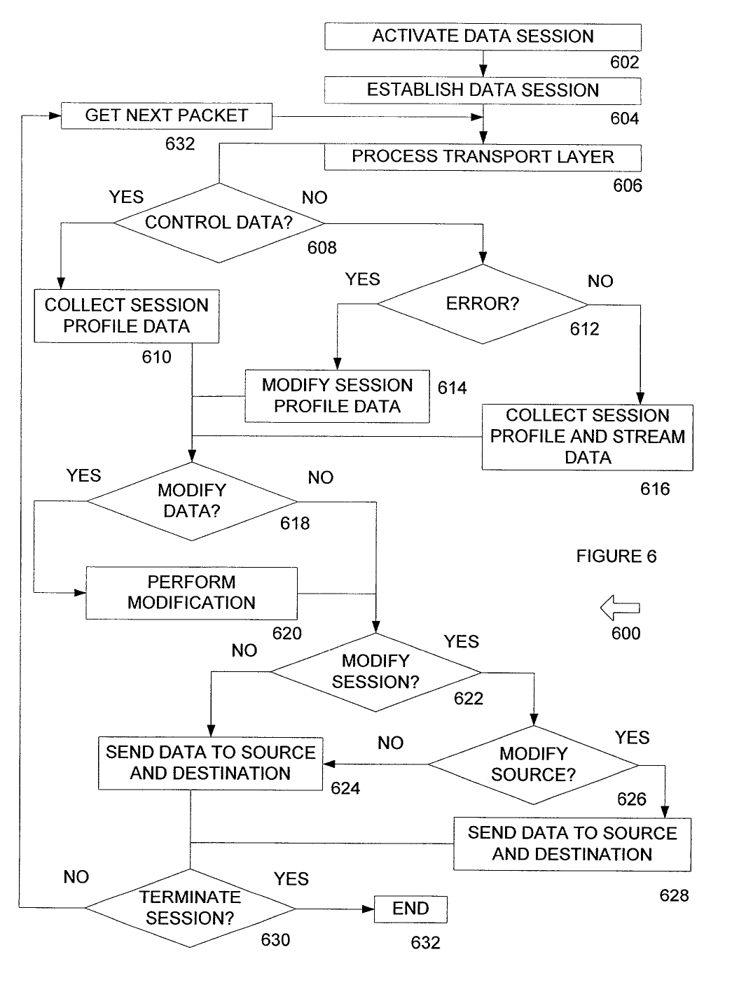

FIG. 6 is a flow chart of a method 600 for processing radio packet data in accordance with an exemplary embodiment of the present invention. Method 600 allows radio packet data to be processed either prior to provision to a gateway node or other suitable wireless packet data network processing point, or for processing by the gateway node prior to processing by the serving node or other suitable wireless packet data network processing points. Likewise, the method can be used after processing data in the serving node, integrated with the gateway node, the radio control system node, or in other suitable manners.

Method 600 begins at 602 where a wireless data session is activated. The wireless data session can be activated when a wireless device enters the service area of a base station, such as when the user is registered with the visitor location register associated with the base station, or at other suitable times. The method then proceeds to 604.

At 604, a wireless data session is established. In one exemplary embodiment, the wireless data session is established when the user enters control commands to cause a data channel to be established. In another exemplary embodiment, a wireless data channel can be established when the wireless device is configured by the base station to receive packet data. The method then proceeds to 606.

At 606, transport layer data is processed, such as the OSI layer 4 data for end-to-end control of transmitted data. In one exemplary embodiment, the protocols governing message structure and network error-checking can be processed at 606. The method then proceeds to 608.

At 608, it is determined whether control data is being transmitted. If so, the method proceeds to 610 where session profile data is collected, after which the method proceeds to 618. If it is determined that control data is not being transmitted at 608, the method proceeds to 612.

At 612, it is determined whether error data is being transmitted, such as Internet Control Message Protocol (ICMP) data. If error data is being transmitted, the method proceeds to 614 where session profile data is modified, such as to correct the source of error, provide corrected packet data, or for other suitable purposes. The method then proceeds to 618. Likewise, if it is determined at 612 that error data is not being transmitted, the method proceeds to 616 where session profile and stream data is collected. The method then proceeds to 618.

At 618, it is determined whether it is necessary to modify data characteristics in response to the session profile data collected, the stream information collected, or the session profile data that has been modified, such as quality of service parameters, reliability parameters, or other suitable data. If modifications are not necessary, the method proceeds to 622. Otherwise, the method proceeds to 620 where the modifications are performed, such as at a wireless content switch. The method then proceeds to 622.

At 622, it is determined whether a session characteristic change is required in response to the session profile data collected, the stream information collected, or the session profile data that has been modified, such as to implement quality of service changes, reliability changes, for monitoring, or to implement other suitable changes. In one exemplary embodiment, session characteristic changes can be required based on who a user is, what a user is doing, or other criteria. The session characteristic change can include control commands generated by a content switch to a gateway node, serving node, or other suitable systems for re-allocation of bandwidth, processing resources, or other resources that are required to control quality of service, reliability, monitoring, or other functionality. If it is determined that session modifications are required at 622, the method proceeds to 626. Otherwise, the method proceeds to 624 where the data is transmitted to the source and destination. The method then proceeds to 630.

At 626, it is determined whether any changes need to be performed at the source to implement the session modifications. For example, the data transmission rate, data format, or other suitable parameters may need to be modified at the source in order to implement the session characteristic changes. If it is determined that no source changes are required, then the method proceeds to 624. Otherwise, the method proceeds to 628 where control data or other suitable data is transmitted to the source and destination to cause the required changes to be implemented, such as data transmission rate changes, data format changes, or other suitable changes. The method then proceeds to 630.

At 630, it is determined whether the session is to be terminated. If the session is to continue, the method proceeds to 632 where the next data packet is received. Otherwise, the method proceeds to 634 where the session is terminated.

In operation, method 600 provides for trigger points that will cause wireless data to be analyzed where necessary to provide wireless content switch functionality. Method 600 sets predetermined trigger points that will facilitate or cause a review of data fields to determine whether modification is necessary to support wireless content switch applications, and receives additional triggers as necessary to facilitate the provision of wireless content switch applications.

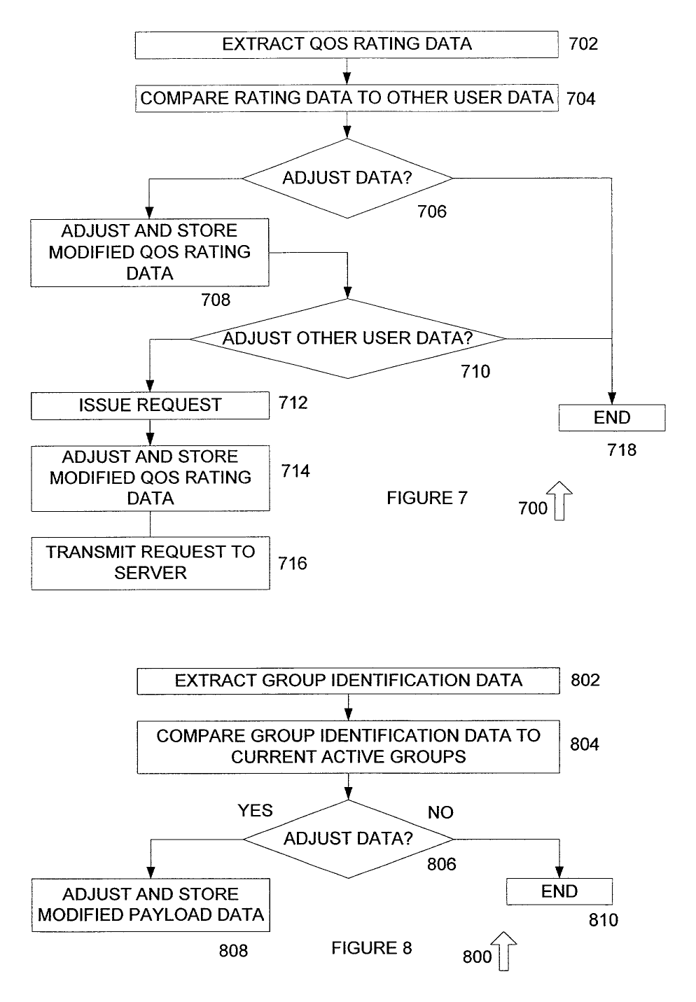

FIG. 7 is a flow chart of a method 700 for providing quality of service functionality in a wireless content switch in accordance with an exemplary embodiment of the present invention. Method 700 begins at 702 where quality of service rating data is extracted from the data packet and session information associated with the data packet. The quality of service rating data can include one or more of the following criteria:

Capability of the wireless device

Data errors

Packet loss

Number of data packet retransmissions

Amount of data traffic

Frequency of out-of-sequence data packet delivery

Latency

Jitter

Bit error rates

Bandwidth limitations

Number of users

Radio interference

TCP traffic rate management

At 704 the quality of service rating data is compared to other user data to determine the priority that this application and this user should be assigned. In one exemplary embodiment, the quality of service rating data can include organizational, functional, or other suitable distinguishing data that allows bandwidth allocation and processing allocation to be given priority to predetermined users or applications, such as data that has been determined by cross-referencing the data extracted at 702 to a table of organizational, functional, or other suitable priority data. The method then proceeds to 706.

At 706 it is determined whether the radio packet data must be adjusted in order to support the quality of service allocation performed in step 704. If it is determined at 706 that data adjustment is not required then the method proceeds to 718 and terminates. Otherwise the method proceeds to 708 where radio packet data is adjusted and stored in accordance with the quality of service rating. The method then proceeds to 710.

At 710 it is determined whether other data must be adjusted, such as user data for users that are given lower priority. In one exemplary embodiment, packet data for other users can be dropped, one or more servers can be contacted to buffer or stop the transmission of packet data, or other suitable adjustments can be performed. If it is determined that no other adjustments are required the method proceeds to 718 and terminates. Otherwise the method proceeds to 712 where a request is issued. The request can include a request to a local station, a server, or other suitable request. The method then proceeds to 714 where the modified quality of service rating data is adjusted and stored. The method then proceeds to 716 where a request is transmitted to a server, such as to stop transmission, decrease bandwidth requirements, or take other suitable steps.

In operation, method 700 allows a wireless content switch to monitor radio packet data, and to adjust the radio packet data as required to provide quality of service functionality in a wireless network. Method 700 can provide quality of service management without buffering data at the wireless content switch or other location where quality of service management is being performed, so as to eliminate the processing overhead and hardware required to support buffering.

FIG. 8 is a flow chart of a method 800 for providing multicast functionality in accordance with an exemplary embodiment of the present invention. Method 800 begins at 802 where group identification data is extracted. In one exemplary embodiment, the group identification data can include IMSI data, NSAPI data, MSISDN data, packet data protocol type data, packet data protocol address data, dynamic address identifier data, APN network identifier data, quality of service profile data, serving node address data, mobile station not reachable indicator data, serving node recovery identifier data, Sequence Number Downlink data, Sequence Number Uplink data, charging identifier data, network protocol data unit reordering identifier data, or other suitable data. The method then proceeds to 804.

At 804 group identification data is compared to current active group data. In one exemplary embodiment, a multicast session can be set up where the users that are to be included in the multicast are first identified. If the users are unavailable, out of range, or otherwise not capable of participating, those users may be flagged and periodically checked, such as to determine when the user travels back into range, turns on a handset unit, or performs other suitable functions that make the user available for the multicast. The method then proceeds to 806.

At 806 it is determined whether data must be processed in order to support the multicast functionality, such as to allow the data to be received by all of the participants, on all of the mobile platforms involved, to meet bandwidth requirements, or otherwise. If it is determined that data is not required to be adjusted, the method proceeds to 810 and terminates. Otherwise, the method proceeds to 808 where the multicast data is adjusted and stored in packet data in addition to any required control data that may be necessary to allow the user to participate in the multicast.

In operation, method 800 allows a wireless content switch to access radio packet data so as to perform processing that may be required to provide multicast functionality. Method 800 thus facilitates the reception and transmission of data from a single source to a multicast source, from one of the multicast parties to the other multicast parties, or from all the multicast parties back to the multicast source.

Although exemplary embodiments of a system and method for wireless packet data content switching have been described in detail herein, those skilled in the art will also recognize that various substitutions and modifications can be made to the systems and methods without departing from the scope and spirit of the appended claims.

What is claimed is:

1. A system for processing wireless data comprising:
a gateway radio packet interface receiving radio packet data from a gateway radio packet node;
a content switch system coupled to the gateway radio packet interface, the content switch system receiving the radio packet data, extracting one or more predetermined data fields from the radio packet data, and performing one or more predetermined actions based on the extracted data fields; and
a serving radio packet interface coupled to the content switch system, the serving radio packet interface transmitting the radio packet data to a serving radio packet node.

2. The system of claim 1 wherein the content switch system further comprises a quality of service system and extracts user priority data from the radio packet data, wherein the quality of service system allocates bandwidth based upon the user priority data and stores bandwidth allocation data in the radio packet data.

3. The system of claim 1 wherein the content switch system further comprises a multicast system and extracts multicast setup data and user identification data from the radio packet data, wherein the multicast system addresses the radio packet data based upon the user identification data and the multicast setup data.

4. The system of claim 1 wherein the gateway radio packet interface comprises a gateway tunneling protocol system extracting gateway tunneling protocol data from the radio packet data and providing the gateway tunneling protocol data to the content switch system.

5. The system of claim 1 wherein the content switch system further comprises a serving handoff system and the serving radio packet interface transmits the radio packet data to at least two serving radio packet nodes, wherein the serving handoff system extracts the data fields from the radio packet data when the radio packet data is transferred from a first serving radio packet node to a second serving radio packet node.

6. The system of claim 1 wherein the content switch system further comprises a network handoff system and the serving radio packet interface transmits the radio packet data to at least two serving radio packet nodes, wherein the network handoff system extracts the data fields from the radio packet data when the radio packet data is transferred from a first serving radio packet node to a second serving radio packet node.

7. A system for processing wireless data comprising:
a content switch system coupled to a packet network, the content switch system receiving radio packet data from the packet network, extracting one or more predetermined data fields from the radio packet data, and performing one or more predetermined actions based on the extracted data fields; and
a gateway radio packet interface receiving the radio packet data from the content switch system and transmitting the radio packet data to a gateway radio packet node.

8. The system of claim 7 wherein the gateway radio packet interface comprises an Internet protocol system, wherein the radio packet data is received from the packet network contained within an Internet protocol packet, and the Internet protocol system extracts the radio packet data from the internet protocol packet.

9. The system of claim 7 wherein the content switch system further comprises a serving handoff system transmitting the radio packet data to at least two serving radio packet nodes, wherein the serving handoff system extracts the data fields from the radio packet data when the radio packet data is transferred from a first serving radio packet node to a second serving radio packet node.

10. The system of claim 7 wherein the content switch system further comprises a network handoff system transmitting the radio packet data to at least two serving radio packet nodes, wherein the network handoff system extracts the data fields from the radio packet data when the radio packet data is transferred from a first serving radio packet node to a second serving radio packet node.

11. The system of claim 7 wherein the content switch system further comprises a quality of service system and extracts user priority data from the radio packet data, wherein the quality of service system allocates bandwidth based upon the user priority data and stores bandwidth allocation data in the radio packet data.

12. The system of claim 7 wherein the content switch system further comprises a multicast system and extracts multicast setup data and user identification data from the radio packet data, wherein the multicast system addresses the radio packet data based upon the user identification data and the multicast setup data.

13. A method for processing wireless data comprising:
receiving radio packet data;
determining whether a trigger event has occurred;
extracting one or more first data fields from the radio packet data if the trigger event has occurred;
performing a predetermined function using the one or more data fields to generate one or more second data fields;
storing the second data fields in the radio packet data to create modified radio packet data; and
transmitting the modified radio packet data to a serving radio packet node.

14. The method of claim 13 wherein receiving the radio packet data comprises receiving the radio packet data from a gateway radio packet node.

15. The method of claim 13 wherein receiving the radio packet data comprises receiving the radio packet data from a packet network, wherein the radio packet data is contained within an Internet protocol packet.

16. The method of claim 13 wherein determining whether a trigger event has occurred comprises determining whether one of the group of events comprising activation of a packet data protocol channel, serving radio packet node handoff, mobile network handoff, or receipt of a request for radio packet data modification has occurred.

17. The method of claim 13 wherein extracting one or more first data fields from the radio packet data if the trigger event has occurred comprises extracting one or more of the group of data fields comprising an International Mobile Subscriber Identity, a Network Layer Service Access Point Identifier, a Mobile Station ISDN number, a packet data protocol type, a packet data protocol address, a dynamic address identifier, an APN network identifier, a quality of service profile, a serving GPRS support node address, a mobile station not reachable indicator, a serving GPRS support node recovery identifier, a Sequence Number Downlink, a Sequence Number Uplink, a charging identifier, and a network protocol data unit reordering identifier.

18. The method of claim 13 wherein performing the predetermined function using the one or more data fields to generate one or more second data fields comprises one or more of the functions comprising determining transmission priority using a quality of service profile, determining whether to transmit multicast data using an International Mobile Subscriber Identity, determining whether a next radio packet data packet has been received using a Sequence Number Downlink or a Sequence Number Uplink, and determining network resource allocation using a mobile station not reachable indicator.

19. The method of claim 13 wherein storing the second data fields in the radio packet data to create the modified radio packet data comprises storing one or more of the group of data fields comprising a International Mobile Subscriber Identity, a Network Layer Service Access Point Identifier, a Mobile Station ISDN number, a packet data protocol type, a packet data protocol address, a dynamic address identifier, an APN network identifier, a quality of service profile, a serving GPRS support node address, a mobile station not reachable indicator, a serving GPRS support node recovery identifier, a Sequence Number Downlink, a Sequence Number Uplink, a charging identifier, and a network protocol data unit reordering identifier.

20. The method of claim 13 wherein transmitting the modified radio packet data to the serving radio packet node comprises transmitting the modified radio packet data inside of an Internet protocol packet to a gateway radio packet node.
